(19) United States
(12) Patent Application Publication
(10) Pub. No.: US 2025/0016024 A1
(43) Pub. Date: Jan. 9, 2025

(54) CAN COMMUNICATION APPARATUS AND METHOD

(71) Applicant: SAMSUNG SDI CO., LTD., Yongin-si (KR)

(72) Inventors: Jinhyuk PARK, Yongin-si (KR); Taehyoung LA, Yongin-si (KR); Yoonjoong KIM, Yongin-si (KR)

(21) Appl. No.: 18/486,000

(22) Filed: Oct. 12, 2023

(30) Foreign Application Priority Data
Jul. 3, 2023 (KR) 10-2023-0085835

(51) Int. Cl. H04L 12/40; H04L 12/12

(52) U.S. Cl. CPC H04L 12/40032; H04L 12/12; H04L 12/40039; H04L 2012/40215

(57) ABSTRACT

A controller area network (CAN) communication apparatus that communicates through a CAN bus may be provided, the CAN communication apparatus including a CAN communication circuit including a first CAN transceiver connected to the CAN bus, and configured to transmit and receive CAN data through the first CAN transceiver, and a repeater circuit configured to relay CAN data on the CAN bus by setting a connection with the CAN bus in a repeater mode.

### CROSS-REFERENCE TO RELATED APPLICATION

The present application claims priority to and the benefit of Korean Patent Application No. 10-2023-0085835, filed on Jul. 3, 2023, in the Korean Intellectual Property Office, the entire disclosure of which is incorporated herein by reference.

### BACKGROUND

### 1. Field

The present disclosure relates to a controller area network (CAN) communication apparatus and method.

### 2. Description of Related Art

An energy storage system (ESS) refers to a device that stores electricity, and that makes the electricity available if suitable. The ESS may include a battery, a battery management system (BMS), and a power conversion system (PCS) or an energy management system (EMS).

The ESS may transmit and receive various information, such as battery status and protection operation within the system, through a controller area network (CAN) communication.

The composition and installation environment of the ESS may be varied, and as a result, the actual wire length of CAN communication can be relatively long. At this time, if a problem occurs due to the communication distance, an external CAN repeater may be installed at a suitable distance.

The external CAN repeater may be a device used to extend the distance of a CAN bus and a corresponding node. Using the external CAN repeater can solve the problem of weakening communication due to distance, and the external CAN repeater may be serially connected to the CAN bus from the outside. Furthermore, because there is no feedback or monitoring of the external CAN repeater, communication reliability may be reduced, and the cost of installing the external CAN repeater may be increased.

### SUMMARY

One or more embodiments may provide a CAN communication apparatus, and a method capable of increasing a physically limited CAN communication distance without installing an external CAN repeater.

According to one or more embodiments, a controller area network (CAN) communication apparatus that communicates through a CAN bus may be provided, the CAN communication apparatus including a CAN communication circuit including a first CAN transceiver connected to the CAN bus, and configured to transmit and receive CAN data through the first CAN transceiver, and a repeater circuit configured to relay CAN data on the CAN bus by setting a connection with the CAN bus in a repeater mode.

The CAN communication circuit may further include a micro controller unit (MCU) configured to set the repeater mode to on or to off according to a setup signal.

The repeater circuit may include a first switch serially connected to the CAN bus, a second CAN transceiver connected to the CAN bus, a third CAN transceiver connected to the CAN bus, an arbitration logic configured to transmit and receive the CAN data between the second CAN transceiver and the third CAN transceiver, a second switch connected between the CAN bus and the second CAN transceiver, and a third switch connected between the CAN bus and the third CAN transceiver, and wherein the MCU is configured to set the first switch to an open state, and to set the second switch and the third switch to a closed state, to turn on the repeater mode based on the setup signal.

The MCU may be configured to set the first switch to a closed state, and to set the second switch and the third switch to an open state, to turn off the repeater mode based on the setup signal.

The repeater circuit may further include a fourth switch configured to supply a power voltage to the second CAN transceiver and the third CAN transceiver, or to cut off the power voltage, wherein the MCU is configured to control the fourth switch to be closed if the repeater mode is turned on.

The arbitration logic may be configured to feed back the CAN data that is transmitted and received between the second CAN transceiver and the third CAN transceiver to the MCU, wherein the MCU is configured to monitor an operation state of the repeater mode using feedbacked CAN data.

According to one or more other embodiments, a controller area network (CAN) communication method of a CAN communication apparatus connected to the CAN bus may be provided, the CAN communication method including performing CAN communication through a first CAN transceiver connected to the CAN bus, operating in a repeater mode by setting a connection with the CAN bus based on a setup signal, and relaying CAN data on the CAN bus in the repeater mode.

The CAN communication apparatus may include a micro controller unit (MCU) configured to control the CAN communication through the first CAN transceiver, a first switch serially connected to the CAN bus, a second CAN transceiver connected to the CAN bus, a third CAN transceiver connected to the CAN bus, an arbitration logic configured to transmit and receive the CAN data between the second CAN transceiver and the third CAN transceiver, a second switch connected between the CAN bus and the second CAN transceiver, and a third switch connected between the CAN bus and the third CAN transceiver, wherein the operating in the repeater mode includes setting the first switch to an open state, and setting the second switch and the third switch to a closed state.

The CAN communication method may further include turning off the repeater mode by setting the first switch to an open state, and by setting the second switch and the third switch to a closed state, to disconnect from the CAN bus based on the setup signal.

The operating in the repeater mode may further include supplying a power supply voltage to the second CAN transceiver and to the third CAN transceiver, wherein the turning off the repeater mode further includes cutting off the power supply voltage to the second CAN transceiver and to the third CAN transceiver.

The CAN communication method may further include monitoring an operation state of the repeater mode using the CAN data that is sent between the second CAN transceiver and the third CAN transceiver.

The monitoring may include transmitting the CAN data generated by the MCU through the first CAN transceiver, and monitoring the operation state of the repeater mode through comparison of the CAN data generated by the MCU and the CAN data sent between the second CAN transceiver and the third CAN transceiver.

### BRIEF DESCRIPTION OF THE DRAWINGS

FIG. 1 is a diagram showing an example of a CAN communication network according to one or more embodiments.

FIG. 2 is a diagram illustrating a CAN communication apparatus according to one or more embodiments.

FIG. 3 is a diagram illustrating an operation of a CAN communication apparatus if a repeater mode is off according to one or more embodiments.

FIG. 4 is a diagram illustrating an operation of a CAN communication apparatus if a repeater mode is on according to one or more embodiments.

FIG. 5 is a flowchart illustrating a method of monitoring an operating state of a repeater mode according to one or more embodiments.

FIG. 6 is a flowchart illustrating a repeater mode setting method according to one or more embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The present disclosure covers all modifications, equivalents, and replacements within the idea and technical scope of the present disclosure. Further, each of the features of the various embodiments of the present disclosure may be combined or combined with each other, in part or in whole, and technically various interlocking and driving are possible. Each embodiment may be implemented independently of each other or may be implemented together in an association.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression such as “at least one of A and B” and “at least one of A or B” may include A, B, or A and B. As used herein, “or” generally means “and/or,” and the term “and/or” includes any and all combinations of one or more of the associated listed items. For example, the expression such as “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

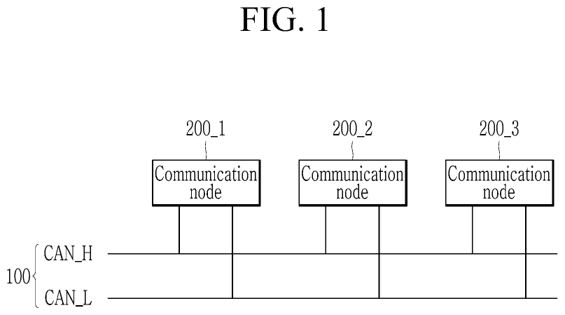

FIG. 1 is a diagram showing an example of a CAN communication network according to one or more embodiments.

Referring to FIG. 1, a controller area network (CAN) communication network may include a plurality of communication nodes 200_1, 200_2, and 200_3 connected through a CAN bus 100. In FIG. 1, only three communication nodes 200_1, 200_2, and 200_3 are shown for convenience, but the present disclosure is not limited thereto.

The communication nodes 200_1, 200_2, and 200_3 may be connected in parallel to the CAN bus 100, and may transmit and receive CAN data to each other. The communication nodes 200_1, 200_2, and 200_3 may be CAN communication apparatuses that perform CAN communication.

The communication nodes 200_1, 200_2, and 200_3 may be, for example, an energy storage system (ESS), a battery management system (BMS), a power conversion system (PCS), a power management system (PMS), or an energy management system (EMS). The communication nodes 200_1, 200_2, and 200_3 may be, for example, electronic control units (ECUs) in a vehicle.

Below, for convenience, the communication nodes 200_1, 200_2, and 200_3 will be referred to as CAN communication apparatuses.

The CAN communication apparatuses 200_1, 200_2, and 200_3 according to one or more embodiments may basically operate in a CAN communication mode that performs CAN communication, and may optionally operate in a repeater mode concurrently or substantially simultaneously with the CAN communication mode.

If the CAN communication apparatuses 200_1, 200_2, and 200_3 operate in a repeater mode, they may perform a repeater function of CAN data.

The CAN bus 100 may transfer a differential signal corresponding to CAN data using two twisted pairs called a CAN high line CAN_H and a CAN low line CAN_L.

The CAN bus 100 may have a limited maximum communication distance that can connect CAN communication apparatuses at both ends. Therefore, a CAN communication apparatus outside the maximum communication distance cannot perform CAN communication with a CAN communication apparatus within the maximum communication distance. However, if the CAN communication apparatus at both ends operates in repeater mode, it is possible to relay CAN data with the CAN communication apparatus outside the maximum communication distance, thereby increasing the maximum communication distance that is physically limited on the CAN bus 100.

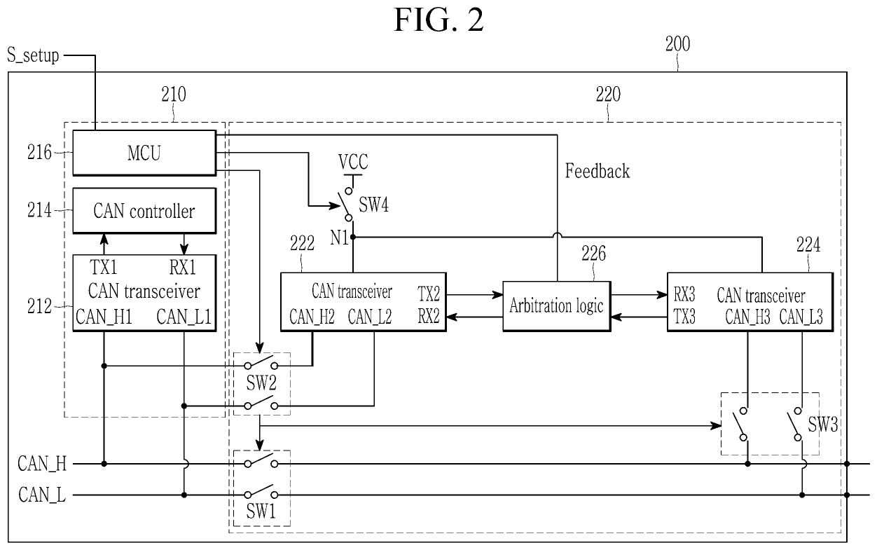

FIG. 2 is a diagram illustrating a CAN communication apparatus according to one or more embodiments.

Referring to FIG. 2, the CAN communication apparatus 200 may include a CAN communication circuit 210 and a repeater circuit 220.

The CAN communication circuit 210 may perform CAN communication. The CAN communication circuit 210 may include a CAN transceiver 212, a CAN controller 214, and a micro controller unit (MCU) 216.

The CAN transceiver 212, the CAN controller 214, and the MCU 216 may operate in a CAN communication mode. The CAN communication mode may be a basic operation mode of the CAN communication circuit 210.

The CAN transceiver 212 may include a CAN high terminal CAN_H1, a CAN low terminal CAN_L1, a transmission terminal TX1, and a reception terminal RX1. The CAN high terminal CAN_H1 and the CAN low terminal CAN_L1 may be connected to the CAN high line CAN_H and the CAN low line CAN_L of the CAN bus 100, respectively. The transmission terminal TX1 and the reception terminal RX1 may be connected to the CAN controller 214.

If the CAN transceiver 212 receives a transmission signal of a TTL (Transistor-Transistor Logic) level from the CAN controller 214 through the reception terminal RX1, it may convert the transmission signal into a differential signal of the CAN communication standard, and may output the differential signal to the CAN high line CAN_H and the CAN low line CAN_L of the CAN bus 100. If the CAN transceiver 212 receives a differential signal from the CAN high line CAN_H and the CAN low line CAN_L of the CAN bus 100, it may convert the differential signal into a reception signal of a TTL level, and may transmit it to the CAN controller 214 through the transmission terminal TX1.

The CAN controller 214 may transmit and receive a transmission signal or reception signal of a TTL level according to a command of the MCU 216. The CAN controller 214 may check whether the CAN bus 100 is being used by a CAN controller of another CAN communication apparatus, and if the CAN bus 100 is being used by the CAN controller of another CAN communication apparatus, all communication apparatuses connected to the CAN bus 100 may check data, which may be used for by the communication apparatuses, through an identifier (ID) value included in the CAN data. At this time, unnecessary data may be ignored, and only the data suitable for the respective communication apparatuses may be received. In one or more embodiments, if a plurality of CAN communication apparatuses concurrently or substantially simultaneously transmit data to the CAN bus 100, the highest priority CAN communication apparatus may automatically access the CAN bus 100 based on the ID value. The data of a CAN communication apparatus with a high priority may be guaranteed the right or ability to use the CAN bus 100, and other CAN communication apparatuses may wait and automatically perform transmission in the next bus cycle.

The MCU 216 may generate CAN data to be shared with different CAN communication apparatuses through CAN communication. The MCU 216 may command the CAN controller 214 to transmit the generated CAN data, or to receive CAN data from the CAN controller 214.

A general CAN communication apparatus may include only the CAN communication circuit 210. In one or more embodiments, the CAN communication apparatus 200 according to one or more embodiments may further include a repeater circuit 220 to selectively operate in a repeater mode based on a setup signal S_setup.

The repeater circuit 220 may selectively operate based on the setup signal S_setup. The repeater circuit 220 may set a connection with the CAN bus 100 if the repeater circuit 220 is set to the repeater mode, and may perform a repeater function of CAN communication.

The repeater circuit 220 may further include CAN transceivers 222 and 224, arbitration logic 226, and switches SW1, SW2, SW3, and SW4.

The first switches SW1 may be connected in series to a CAN high line CAN_H and a CAN low line CAN_L of the CAN bus 100, respectively. Therefore, if the first switches SW1 are in an open state, a corresponding portion of the CAN bus 100 may be disconnected (open). If the first switches SW1 are in a closed state, a corresponding portion of the CAN bus 100 can be connected (closed). If the repeater mode is set to on, the first switches SW1 may be set to an open state. If the repeater mode is set to off, the first switches SW1 may be set to a closed state.

The second switches SW2 may be connected between the CAN high line CAN_H and the CAN transceiver 222, and between the CAN low line CAN_L and the CAN transceiver 222, respectively. If the repeater mode is set to on, the second switches SW2 may be set to a closed state. The CAN transceiver 222 may be connected to the CAN bus 100 if the second switches SW2 are closed.

The third switches SW3 may be connected between the CAN high line CAN_H and the CAN transceiver 224, and between the CAN low line CAN_L and the CAN transceiver 224, respectively. If the repeater mode is set to on, the third switches SW3 may be set to a closed state. The CAN transceiver 224 may be connected to the CAN bus 100 if the third switches SW3 are closed.

In one or more embodiments, in the repeater mode, first switches SW1 are set to an open state, and the second and third switches SW2 and SW3 are set to a closed state, so that the CAN bus 100 may be connected through the CAN transceiver 222 and the CAN transceiver 224.

The CAN transceiver 222 may include a CAN high terminal CAN_H2, a CAN low terminal CAN_L2, a transmission terminal TX2, and a reception terminal RX2. The CAN high terminal CAN_H2 and the CAN low terminal CAN_L2 may be connected to the CAN high line CAN_H and the CAN low line CAN_L of the CAN bus 100, respectively. The transmission terminal TX2 and the reception terminal RX2 may be connected to the arbitration logic 226.

The CAN transceiver 224 may include a CAN high terminal CAN_H3, a CAN low terminal CAN_L3, a transmission terminal TX3, and a reception terminal RX3. The CAN high terminal CAN_H3 and the CAN low terminal CAN_L3 may be connected to the CAN high line CAN_H and the CAN low line CAN_L of the CAN bus 100, respectively. The transmission terminal TX3 and the reception terminal RX3 may be connected to the arbitration logic 226.

The arbitration logic 226 may transmit and receive CAN data between the CAN transceiver 222 and the CAN transceiver 224. The arbitration logic 226 may receive CAN data transmitted from the transmission terminal TX2 of the CAN transceiver 222, and may transmit the data to the reception terminal RX3 of the CAN transceiver 224. The arbitration logic 226 may receive CAN data transmitted from the transmission terminal TX3 of the CAN transceiver 224, and may transmit the data to the reception terminal RX2 of the CAN transceiver 222. The arbitration logic 226 may also feedback CAN data received between the CAN transceivers 222 and CAN transceivers 224 to MCU 216.

The MCU 216 may monitor an operation state of the repeater mode of the CAN communication apparatus 200 using the feedbacked CAN data.

The fourth switch SW4 may be connected between a power terminal for supplying the power supply voltage VCC and a node N1. The node N1 may be connected to the CAN transceiver 222 and the CAN transceiver 224. If the repeater mode is set to on, the fourth switch SW4 may be set to a closed state. If the fourth switch SW4 is in a closed state, the power supply voltage VCC may be supplied to the CAN transceiver 222 and to the CAN transceiver 224. If the repeater mode is set to off, the fourth switch SW4 may be set to an open state. If the fourth switch SW4 is in an open state, the power supply voltage VCC may not be supplied to the CAN transceiver 222 and the CAN transceiver 224.

The operation mode of the CAN communication apparatus 200 may be determined according to a setup signal S_setup input from the outside. As an example, the setup signal S_setup may have a high level or a low level, and if the setup signal S_setup with the high level is input, the CAN communication apparatus 200 may set the repeater mode to on, and if the setup signal S_setup with the low level is input, the CAN communication apparatus 200 may set the repeater mode to off.

The MCU 216 may control the switches SW1, SW2, SW3, and SW4 to set the repeater mode to on or to off according to the setup signal S_setup input from the outside.

The MCU 216 may set the repeater mode to be off by controlling the first switches SW1 to be closed and the second, third, and fourth switches SW2, SW3, and SW4 to be open. Then, the CAN communication apparatus 200 may operate only in the CAN communication mode.

The MCU 216 may set the repeater mode to be on by controlling the first switches SW1 to be opened and the second, third, and fourth switches SW2, SW3, and SW4 to be closed. Then, the CAN communication apparatus 200 may also operate in a repeater mode together with the CAN communication mode.

If the CAN communication apparatus 200 operates in a repeater mode and performs a repeater function, a physical communication distance of CAN communication may be increased and a communication signal can be strengthened.

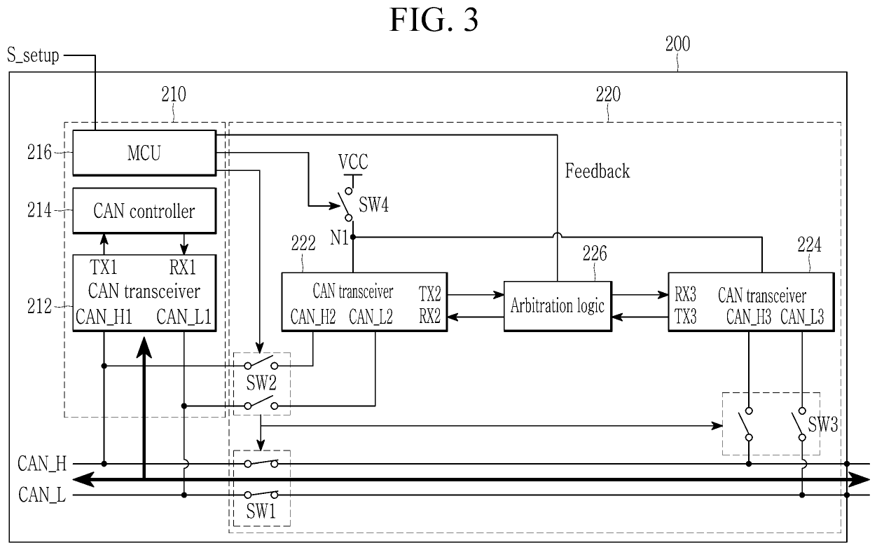

FIG. 3 is a diagram illustrating an operation of a CAN communication apparatus if a repeater mode is off according to one or more embodiments.

Referring to FIG. 3, the repeater mode may be set to off based on the setup signal S_setup.

To set the repeater mode to off, the MCU 216 of the CAN communication apparatus 200 may control the first switches SW1 to a closed state, and may control the second, third, and fourth switches SW2, SW3, and SW4 to an open state. At this time, by setting the second and third switches SW2 and SW3 to an open state, unnecessary input to the CAN transceivers 222 and 224 may be reduced or prevented. In addition, by setting the fourth switch SW4 to the open state, the supply of the power supply voltage VCC to the CAN transceivers 222 and 224 may be cut off to reduce or prevent the likelihood of unintentional operation, such that power consumption of the CAN communication apparatus 200 may be reduced.

If the repeater mode is set to off, the CAN communication apparatus 200 operate only in the CAN communication mode for performing basic CAN communication, and the repeater function of the repeater mode may not be performed. For example, the CAN communication apparatus 200 may receive CAN data transmitted through the CAN bus 100, may generate CAN data to be transmitted, and may transmit the CAN data to the CAN bus 100.

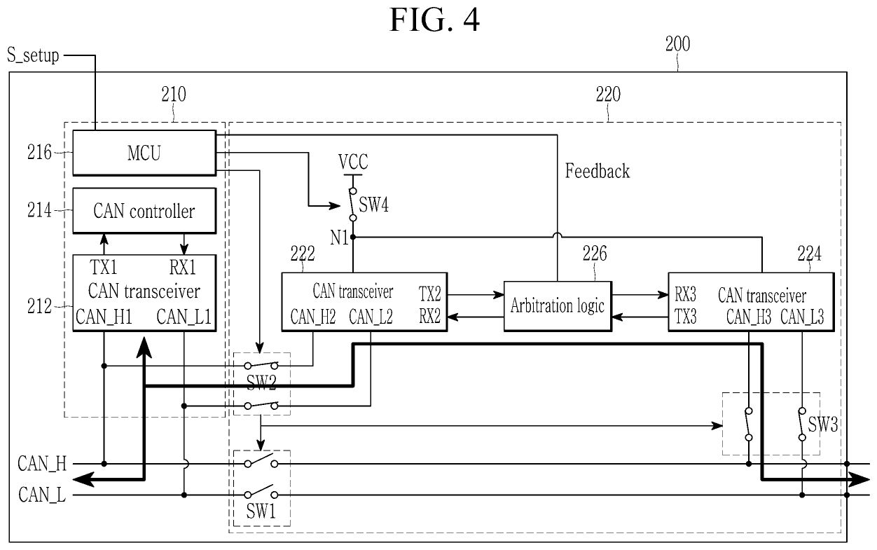

FIG. 4 is a diagram illustrating an operation of a CAN communication apparatus if a repeater mode is on according to one or more embodiments.

Referring to FIG. 4, the repeater mode may be set to on according to the setup signal S_setup. In this case, the CAN communication apparatus 200 may also operate in the repeater mode together with the CAN communication mode.

To set the repeater mode, the MCU 216 of the CAN communication apparatus 200 may control the first switches SW1 to an open state, and may control the second, third, and fourth switches SW2, SW3, and SW4 to a closed state.

If the first switches SW1 are open, the portion of the CAN bus 100, to which the first switches SW1 are connected, is disconnected, so that CAN data cannot be transmitted or received through the portion to which the first switches SW1 are connected.

In one or more embodiments, because the first switches SW1 are open and the second, third, and fourth switches SW2, SW3, and SW4 are closed, the power supply voltage VCC may be supplied to the CAN transceiver 222 and the CAN transceiver 224, so that the CAN transceiver 222 and the CAN transceiver 224 can operate. By operating the CAN transceiver 222 and the CAN transceiver 224, the CAN communication apparatus 200 may be serially connected with CAN bus 100 through the CAN transceiver 222, the arbitration logic 226, and the CAN transceiver 224. Accordingly, CAN data may be transferred to the CAN bus 100 through the CAN transceiver 222, the arbitration logic 226, and the CAN transceiver 224 of the CAN communication apparatus 200. For example, the CAN communication apparatus 200 may perform a repeater function of CAN data.

Also, the CAN transceiver 212 may receive CAN data from the CAN bus 100, and may transmit CAN data generated by the MCU 216 to the CAN bus 100. For example, even if the CAN communication apparatus 200 is set to the repeater mode, it can perform the operation of the CAN communication mode.

In addition, the MCU 216 may monitor the operation state of the repeater mode using the feedbacked CAN data from the arbitration logic 226.

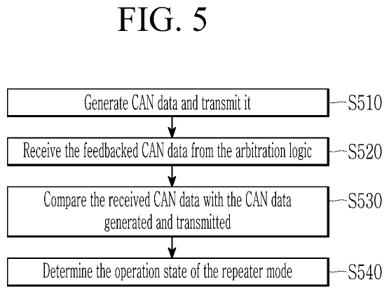

FIG. 5 is a flowchart illustrating a method of monitoring an operating state of a relay mode according to one or more embodiments.

Referring to FIG. 5, the MCU 216 may generate CAN data to be transmitted, and may transmit the CAN data to the CAN bus 100 through the CAN transceiver 212 (S510).

If the CAN communication apparatus 200 operates in repeater mode, CAN data transferred from the CAN transceiver 212 to the CAN bus 100 may be relayed through the CAN transceiver 222, the arbitration logic 226, and the CAN transceiver 224. The arbitration logic 226 may feedback received CAN data to MCU 216.

The MCU 216 may receive the feedbacked CAN data from the arbitration logic 226 (S520).

The MCU 216 may compare the received CAN data with the CAN data that is generated by the MCU 216 and transmitted to the CAN transceiver 212 (S530), and may determine the operation state of the repeater mode based on the comparison result (S540).

For example, if the MCU 216 has the same data as the CAN data that is generated by the MCU 216 and transmitted to the CAN transceiver 212 among the CAN data received from the arbitration logic 226, then it may be determined that the operation state of the repeater mode is good (normal). On the other hand, if the MCU 216 does not have the same data as the CAN data that is generated by the MCU 216 and transmitted to the CAN transceiver 212 among the CAN data received from the arbitration logic 226, it may be determined that the operation state of the repeater mode is poor (error). If the operation state of the repeater mode is poor (error), the MCU 216 may output an alarm signal notifying it.

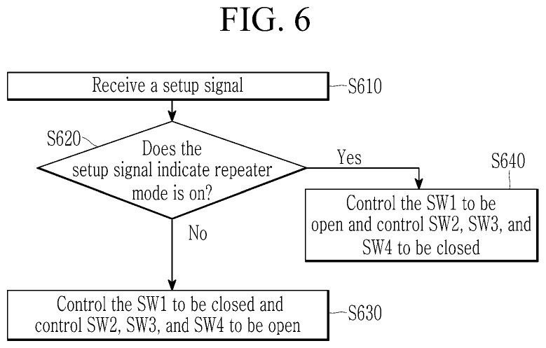

FIG. 6 is a flowchart illustrating a repeater mode setting method according to one or more embodiments.

Referring to FIG. 6, the MCU 216 may receive a setup signal S_setup (S610).

The MCU 216 may set the repeater mode to on or to off based on the setup signal S_setup.

If the setup signal S_setup indicates the repeater mode is to be set to off (S620), the MCU 216 may control the first switches SW1 to be closed and may control the second, third, and fourth switches SW2, SW3, and SW4 to be open (S630). In this way, the CAN communication apparatus 200 may set the repeater mode to off, and may operate in a basic CAN communication mode.

In one or more embodiments, if the setup signal S_setup indicates the repeater mode is to be set to on (S620), the MCU 216 may control the first switches SW1 to be open and may control the second, third, and fourth switches SW2, SW3, and SW4 to be closed (S640). In this way, the portion where the first switches SW1 are located in the CAN bus 100 may be open, the CAN bus 100 may be connected in series through the CAN transceiver 222, the arbitration logic 226 and the CAN transceiver 224, and the CAN communication apparatus 200 may perform a repeater operation in a repeater mode through the CAN transceiver 222, the arbitration logic 226 and the CAN transceiver 224.

According to at least one or more embodiments, it is possible to increase the CAN communication distance having a physical limit on the CAN bus without installing an external repeater, to strengthen the CAN communication signal, and to increase the number of nodes accessible on the CAN bus. In addition, reliability of extended communication functions can be secured through monitoring of relay operations.

Although the embodiments of the present disclosure have been described in detail above, the scope of the present disclosure is not limited thereto, and various modifications and improvements of those skilled in the art using the basic concepts of the present disclosure defined in the following claims are also included in the present disclosure, with functional equivalents of the claims to be included therein.

Description of Some Reference Characters

| | |
|---|---|
| 100: CAN bus | 200: CAN communication apparatus |
| 210: CAN communication circuit | 220: Repeater circuit |
| 212, 222, 224: CAN transceiver | 214: CAN controller |
| 216: MCU | 226 Arbitration logic |

What is claimed is:

1. A controller area network (CAN) communication apparatus configured to communicate through a CAN bus, the CAN communication apparatus comprising:
a CAN communication circuit comprising a first CAN transceiver connected to the CAN bus, and configured to transmit and receive CAN data through the first CAN transceiver; and
a repeater circuit configured to relay CAN data on the CAN bus by setting a connection with the CAN bus in a repeater mode.

2. The CAN communication apparatus as claimed in claim 1, wherein the CAN communication circuit further comprises a micro controller unit (MCU) configured to set the repeater mode to on or to off according to a setup signal.

3. The CAN communication apparatus as claimed in claim 2, wherein the repeater circuit comprises:
a first switch serially connected to the CAN bus;
a second CAN transceiver connected to the CAN bus;
a third CAN transceiver connected to the CAN bus;
an arbitration logic configured to transmit and receive the CAN data between the second CAN transceiver and the third CAN transceiver;
a second switch connected between the CAN bus and the second CAN transceiver; and
a third switch connected between the CAN bus and the third CAN transceiver, and
wherein the MCU is configured to set the first switch to an open state, and to set the second switch and the third switch to a closed state, to turn on the repeater mode based on the setup signal.

4. The CAN communication apparatus as claimed in claim 3, wherein the MCU is configured to set the first switch to a closed state, and to set the second switch and the third switch to an open state, to turn off the repeater mode based on the setup signal.

5. The CAN communication apparatus as claimed in claim 3, wherein the repeater circuit further comprises a fourth switch configured to supply a power voltage to the second CAN transceiver and the third CAN transceiver, or to cut off the power voltage, and
wherein the MCU is configured to control the fourth switch to be closed if the repeater mode is turned on.

6. The CAN communication apparatus as claimed in claim 3, wherein the arbitration logic is configured to feed back the CAN data that is transmitted and received between the second CAN transceiver and the third CAN transceiver to the MCU, and
wherein the MCU is configured to monitor an operation state of the repeater mode using feedbacked CAN data.

7. A controller area network (CAN) communication method of a CAN communication apparatus connected to a CAN bus, the CAN communication method comprising:
performing CAN communication through a first CAN transceiver connected to the CAN bus;
operating in a repeater mode by setting a connection with the CAN bus based on a setup signal; and
relaying CAN data on the CAN bus in the repeater mode.

8. The CAN communication method as claimed in claim 7, wherein the CAN communication apparatus comprises:
a micro controller unit (MCU) configured to control the CAN communication through the first CAN transceiver;
a first switch serially connected to the CAN bus;
a second CAN transceiver connected to the CAN bus;
a third CAN transceiver connected to the CAN bus;
an arbitration logic configured to transmit and receive the CAN data between the second CAN transceiver and the third CAN transceiver;
a second switch connected between the CAN bus and the second CAN transceiver; and
a third switch connected between the CAN bus and the third CAN transceiver, and
wherein the operating in the repeater mode comprises setting the first switch to an open state, and setting the second switch and the third switch to a closed state.

9. The CAN communication method as claimed in claim 8, further comprising turning off the repeater mode by setting the first switch to the closed state, and by setting the second switch and the third switch to the open state, to disconnect from the CAN bus based on the setup signal.

10. The CAN communication method as claimed in claim 9, wherein the operating in the repeater mode further comprises supplying a power supply voltage to the second CAN transceiver and to the third CAN transceiver, and
wherein the turning off the repeater mode further comprises cutting off the power supply voltage to the second CAN transceiver and to the third CAN transceiver.

11. The CAN communication method as claimed in claim 8, further comprising monitoring an operation state of the repeater mode using the CAN data that is sent between the second CAN transceiver and the third CAN transceiver.

12. The CAN communication method as claimed in claim 11, wherein the monitoring comprises:
transmitting the CAN data generated by the MCU through the first CAN transceiver; and
monitoring the operation state of the repeater mode through comparison of the CAN data generated by the MCU and the CAN data sent between the second CAN transceiver and the third CAN transceiver.
